(19) United States
(12) Patent Application Publication
(10) Pub. No.: US 2024/0329562 A1
(43) Pub. Date: Oct. 3, 2024

(54) DEVELOPING DEVICE

(71) Applicant: FUJIFILM BUSINESS INNOVATION CORP., Tokyo (JP)

(72) Inventors: Sadayuki TSUJINO, Kanagawa (JP); Masanori KATO, Kanagawa (JP); Yoshihisa NAKAO, Kanagawa (JP); Shota IGAWA, Kanagawa (JP); Yoshitaka NAKAJIMA, Kanagawa (JP); Daisuke UCHIMITSU, Kanagawa (JP); Satoshi KONO, Kanagawa (JP); Yasuki TANAKA, Kanagawa (JP)

(73) Assignee: FUJIFILM BUSINESS INNOVATION CORP., Tokyo (JP)

(21) Appl. No.: 18/465,668

(22) Filed: Sep. 12, 2023

(30) Foreign Application Priority Data
Mar. 29, 2023 (JP) 2023-053708
Mar. 29, 2023 (JP) 2023-053711

(51) Int. Cl. G03G 15/08

(52) U.S. Cl. CPC G03G 15/0872; G03G 15/0879; G03G 15/0891; G03G 2215/085

(57) ABSTRACT

A developing device includes a developer moving unit that circularly moves a developer, the developer moving unit including a one-direction transport member that transports the developer in one direction, and an opposite-direction transport member that is disposed below the one-direction transport member and that transports the developer in a direction opposite to the one direction; a facing member that is disposed at a location facing an image carrier and that supplies the image carrier with the developer supplied from the one-direction transport member; a lower transport member that is disposed below the facing member and that transports the developer that has separated from the facing member in the one direction to cause the developer to be supplied to one end portion side of the opposite-direction transport member; and a movement restricting portion that is disposed between the lower transport member and the opposite-direction transport member and that restricts a movement of the developer from the opposite-direction transport member to the lower transport member.

### CROSS-REFERENCE TO RELATED APPLICATIONS

This application is based on and claims priority under 35 USC 119 from Japanese Patent Application No. 2023-053708 filed Mar. 29, 2023 and Japanese Patent Application No. 2023-053711 filed Mar. 29, 2023.

### BACKGROUND

### (i) Technical Field

The present disclosure relates to a developing device.

### (ii) Related Art

Japanese Unexamined Patent Application Publication No. 2018-155873 discloses a storage container including a storage part that stores a developer; conveying members that include shaft parts rotatably supported by the storage part, and conveying parts that are supported by the shaft parts and convey the developer inside the storage part during rotation of the shaft parts; and passage parts that are provided at the conveying parts and allow air to pass therethrough in the axial direction of the shaft parts.

### SUMMARY

To perform development with respect to an image carrier, the developer may be stirred by using a developer moving unit that circularly moves the developer, and the stirred developer may be supplied to the image carrier via a facing member disposed at a location facing the image carrier.

Here, when the developer is supplied to the facing member in the middle of moving of the developer by the developer moving unit that circularly moves the developer, the developer that has not been stirred sufficiently may be supplied to the facing member and may cause deterioration in the quality of an image that is to be formed on the image carrier.

A first object of aspects of non-limiting embodiments of the present disclosure is to suppress, compared with a configuration in which a movement restricting portion that restricts a movement of a developer is not provided, occurrence of a situation in which a developer that has not been sufficiently stirred is supplied to a facing member that is disposed at a location facing an image carrier.

Meanwhile, a developing device may be provided with a facing member that is disposed at a location facing an image carrier and also provided with a functional portion that stirs a developer, and the developer that has been stirred may be supplied to the facing member.

Here, when the developer that has not passed through the functional portion having the function of stirring the developer is supplied to the facing member, a malfunction in which, for example, the quality of an image that is to be formed on the image carrier is deteriorated may easily occur.

A second object of aspects of non-limiting embodiments of the present disclosure is to suppress deterioration in the quality of an image that is to be formed on an image carrier, compared with a configuration in which a developer that has not passed through a functional portion having a function of stirring the developer is supplied to a facing member disposed at a location facing the image carrier.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device including: a developer moving unit that circularly moves a developer, the developer moving unit including a one-direction transport member that transports the developer in one direction, and an opposite-direction transport member that is disposed below the one-direction transport member and that transports the developer in a direction opposite to the one direction; a facing member that is disposed at a location facing an image carrier and that supplies the image carrier with the developer supplied from the one-direction transport member; a lower transport member that is disposed below the facing member and that transports the developer that has separated from the facing member in the one direction to cause the developer to be supplied to one end portion side of the opposite-direction transport member; and a movement restricting portion that is disposed between the lower transport member and the opposite-direction transport member and that restricts a movement of the developer from the opposite-direction transport member to the lower transport member.

### BRIEF DESCRIPTION OF THE DRAWINGS

An exemplary embodiment of the present disclosure will be described in detail based on the following figures, wherein:

FIG. 1 illustrates an image forming apparatus;

FIG. 2 illustrates a developing device as viewed from above;

FIG. 3 is a sectional view of the developing device along line III-III in FIG. 2; and illustrates a state of a cross-section at a central portion of the developing device in the longitudinal direction;

FIG. 4 is a sectional view of the developing device along line IV-IV in FIG. 2;

FIG. 5 is a sectional view of the developing device along line V-V in FIG. 2;

FIG. 6 is a sectional view of the developing device along line VI-VI in FIG. 5;

FIG. 7 is a perspective view of the developing device as viewed obliquely from above;

FIG. 8 is a perspective view of a facing member as viewed from above;

FIG. 9 is a sectional view of the developing device along line IX-IX in FIG. 7;

FIG. 10 is a sectional view of the developing device along line X-X in FIG. 9; and

FIG. 11 is a view for illustrating a fifth movement restricting portion.

### DETAILED DESCRIPTION

Hereinafter, an exemplary embodiment of the present disclosure will be described with reference to the accompanying drawings.

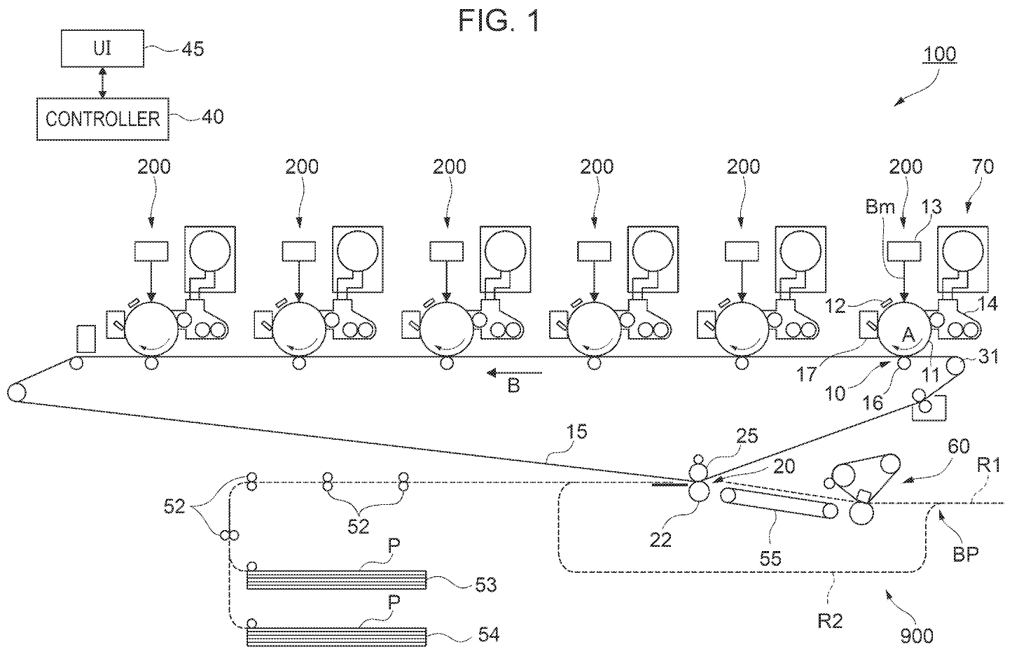

FIG. 1 illustrates an image forming apparatus 100 according to the present exemplary embodiment. FIG. 1 illustrates a state in which the image forming apparatus 100 is viewed from the front side of the image forming apparatus 100.

The image forming apparatus 100 is the image forming apparatus 100 of an intermediate transfer type called a tandem type.

The image forming apparatus 100 is provided with a plurality of image forming units 200 that each form an image that is to be transferred to a sheet P, which is an example of a recording medium.

Each of the image forming units 200 includes a photoconductor drum 11, as an example of an image carrier, and forms a toner image, which is an image to be transferred to the sheet P, onto the photoconductor drum 11 by using a developer that contains a toner. In other words, each of the image forming units 200 forms a toner image that is to be transferred to the sheet P onto the photoconductor drum 11 by using a powdery developer.

The developer in the present exemplary embodiment includes a dry-type carrier and a wet-type toner. Each of the image forming units 200 forms a toner image onto the photoconductor drum 11 by using the carrier and the toner.

The image forming units 200, which are six image forming units, form the toner images onto respective photoconductor drums 11 by using developers of types that differ from each other.

Specifically, in the present exemplary embodiment, among the six image forming units 200, four image forming units 200 form the toner images by using developers of basic colors including yellow, magenta, cyan, and black.

Remaining two image forming units 200 form the toner images by using developers of other than the basic colors, such as of clear, white, gold, silver, pink, green, orange, and the like.

Examples of the developers of other than the basic colors also include a developer that contains a magnetic toner and a developer that contains an electrically conductive toner. In addition, examples of the developers of other than the basic colors also include a developer containing a toner that emits light when irradiated with light such as ultraviolet light or infrared light.

In the present exemplary embodiment, a so-called two-component developer in which a carrier and a toner are mixed is used as the developer. The developer is, however, not limited thereto, and a so-called one-component developer that includes only a toner may be used.

In addition, the image forming apparatus 100 is provided with an intermediate transfer belt 15 and a first transfer portion 10 for transferring toner images that have been formed by the image forming units 200 onto the intermediate transfer belt 15.

Further, the image forming apparatus 100 is provided with a second transfer portion 20 for transferring the toner images that have been transferred on the intermediate transfer belt 15 to the sheet P.

The image forming apparatus 100 is also provided with a fixing device 60 that causes the toner images transferred on the sheet P to be fixed to the sheet P.

The image forming apparatus 100 is further provided with a controller 40 that includes a CPU that executes a program, and controls each portion in the image forming apparatus 100.

In addition, the image forming apparatus 100 is provided with a user interface (UI) 45 that includes a display panel and the like and that receives an instruction from a user and displays information with respect to a user.

Each of the image forming units 200 is provided with a developing device 14. Each of the image forming units 200 is also provided with a developer replenishing device 70 that replenishes the developing device 14 with a developer.

The developing device 14 visualizes an electrostatic latent image on the photoconductor drum 11 with a toner. In other words, the developing device 14 performs development with respect to the photoconductor drum 11, which is an image carrier, and forms an image that is formed with the toner on the photoconductor drum 11.

The developer replenishing device 70 replenishes the developing device 14 with a developer. The developer includes, as described above, a carrier and a toner, and the developer replenishing device 70 replenishes the developing device 14 with, as a developer, the carrier and the toner. In the present exemplary embodiment, the carrier has a positive charge polarity, and the toner has a negative charge polarity.

In each of the image forming units 200, the photoconductor drum 11, as an example of the image carrier, rotates in the arrow A direction.

Each of the image forming units 200 is provided with a charger 12 that charges the photoconductor drum 11, and a laser exposure unit 13, as an example of an exposure device, that forms an electrostatic latent image on the photoconductor drum 11. In FIG. 1, an exposure beam emitted by the laser exposure unit 13 is indicated by the sign Bm. The exposure device may be formed by a device that includes a light source, such as an LED.

In addition, each of the image forming units 200 is provided with a first transfer roller 16 that, at the first transfer portion 10, transfers a toner image formed on the photoconductor drum 11 onto the intermediate transfer belt 15. Each of the image forming units 200 is also provided with a drum cleaner 17 that removes a developer remaining on the photoconductor drum 11.

The intermediate transfer belt 15 is circularly moved at a predetermined speed in the arrow B direction illustrated in FIG. 1 by a driving roller 31 that is driven by a motor, which is not illustrated.

The first transfer portion 10 includes the first transfer roller 16 that is disposed to face the photoconductor drum 11 with the intermediate transfer belt 15 interposed therebetween. Consequently, toner images on the photoconductor drums 11 are electrostatically attracted by the intermediate transfer belt 15 sequentially, and the toner images that are superposed on each other are formed on the intermediate transfer belt 15.

The second transfer portion 20, as an example of a transfer portion, includes a second transfer roller 22 that is disposed on the outer surface side of the intermediate transfer belt 15, and a backup roller 25 that is disposed on the inner surface side of the intermediate transfer belt 15.

In the present exemplary embodiment, the toner images formed by the image forming units 200 and transferred on the intermediate transfer belt 15 are transferred at the second transfer portion 20 to the sheet P that is transported to the second transfer portion 20.

In the present exemplary embodiment, a reversing mechanism 900 that reverses the sheet P is further provided.

The reversing mechanism 900 reverses the front and back sides of the sheet P that has one surface on which the toner images have been transferred at the second transfer portion 20, and supplies the sheet P again to the second transfer portion 20.

Consequently, in the present exemplary embodiment, the toner images are formed on both sides of the sheet P.

Specifically, in the present exemplary embodiment, the reversing mechanism 900 sends the sheet P that has passed through the fixing device 60 to a branch path R2 branched from a sheet transport path R1, thereby reversing the front and back sides of the sheet P. Specifically, after the sheet P passes through a branch portion BP, the reversing mechanism 900 transports the sheet P in a reverse direction and sends the sheet P to the branch path R2.

On the upstream side of the second transfer portion 20, the branch path R2 merges with the sheet transport path R1. Consequently, in the present exemplary embodiment, the sheet P with the front and back sides thereof reversed is supplied again to the second transfer portion 20. In this case, toner images are formed not only on one side of the sheet P but also on the other side thereof, and the toner images are thus formed on both sides of the sheet P.

The flow of processing performed in the image forming apparatus 100 will be described.

The image forming apparatus 100 receives, for example, image data that is output from an image reader or a computer, which is not illustrated. Then, the image data is subjected to image processing. Consequently, pieces of image data each corresponding to one of the plurality of image forming units 200 is generated.

Specifically, for example, image data that is to be used to form images with the developers of the basic colors including yellow, magenta, cyan, and black, and image data that is to be used to form images with developers of other than the basic colors are generated. The generated image data is output to the laser exposure units 13 provided at the image forming units 200.

In accordance with the input image data, the laser exposure units 13 irradiates the photoconductor drums 11 with the exposure beam Bm emitted from, for example, a semiconductor laser.

In the present exemplary embodiment, after the surfaces of the photoconductor drums 11 are charged by the chargers 12, scanning exposure with respect to the surfaces is performed by the laser exposure units 13. Consequently, an electrostatic latent image is formed on the surface of each of the photoconductor drums 11.

Next, the developing devices 14 perform developing processing, and a toner image is formed on each of the photoconductor drums 11. The toner images are transferred at the first transfer portion 10 onto the intermediate transfer belt 15.

After the toner images are transferred onto the intermediate transfer belt 15, the toner images are moved to the second transfer portion 20 by the movement of the intermediate transfer belt 15. At this time, the sheet P from a first sheet storage 53 or a second sheet storage 54 is transported by a transport roller 52 and the like to the second transfer portion 20.

Then, the toner images on the intermediate transfer belt 15 are electrostatically transferred at the second transfer portion 20 onto the sheet P collectively.

Thereafter, the sheet P on which the toner images are transferred separates from the intermediate transfer belt 15 and is transported to a transport belt 55. The transport belt 55 transports the sheet P to the fixing device 60.

The sheet P that has been transported to the fixing device 60 is heated and pressurized at the fixing device 60. Consequently, the toner images on the sheet P are fixed to the sheet P. The sheet P is then discharged from the image forming apparatus 100.

When toner images are to be formed on both sides of the sheet P, the sheet P is supplied again to the second transfer portion 20 through the branch path R2 after the sheet P passes through the fixing device 60.

Then, at the second transfer portion 20, the toner images are transferred to the other side of the sheet P. Thereafter, the sheet P passes through the fixing device 60 again, and the toner images transferred on the other surface are fixed to the sheet P.

The developing device 14 will be described.

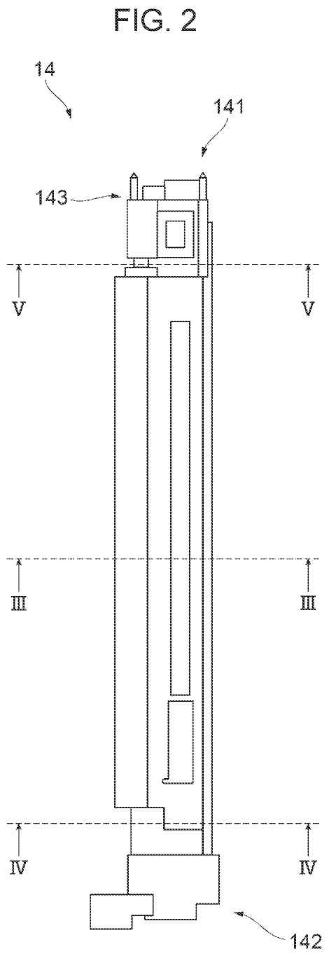

FIG. 2 illustrates the developing device 14 as viewed from above.

When installed in the image forming apparatus 100, the developing devices 14 are disposed to extend in the depth direction of the image forming apparatus 100. The developing devices 14 each have one end portion 141 and another end portion 142 that differ from each other in terms of positions thereof in the longitudinal direction.

In installation of the developing devices 14 with respect to the image forming apparatus 100, each of the developing devices 14 is installed with respect to the image forming apparatus 100 such that the one end portion 141 is located on the rear side of the image forming apparatus 100 and the other end portion 142 is located on the front side of the image forming apparatus 100.

The one end portion 141 of each of the developing devices 14 is provided with a driving-force receiver 143 that receives a driving force.

In the present exemplary embodiment, a driving force from a driving source (not illustrated), such as a motor, provided on the body side of the image forming apparatus 100 is transmitted to the driving-force receiver 143.

The driving-force receiver 143 is interlocked with a transport member and the like (described later) provided inside the developing device 14. In the present exemplary embodiment, the driving force from the driving source being transmitted to the driving-force receiver 143 rotates the transport member and the like.

In the present exemplary embodiment, as described later, four members, including a one-direction transport member, an opposite-direction transport member, a facing member, and a lower transport member, are provided as members that rotate by receiving the driving force from the driving source. The driving-force receiver 143 may be provided correspondingly to each of the four members. Then, the driving force from the driving source may be transmitted to each of the four driving-force receivers 143.

Alternatively, less than four driving-force receivers 143, for example, one driving-force receiver 143 may be provided. Then, the driving force transmitted from the driving source to the driving-force receiver 143 may be transmitted through a transmitting mechanism (not illustrated) provided at the developing device 14 to each of the four members.

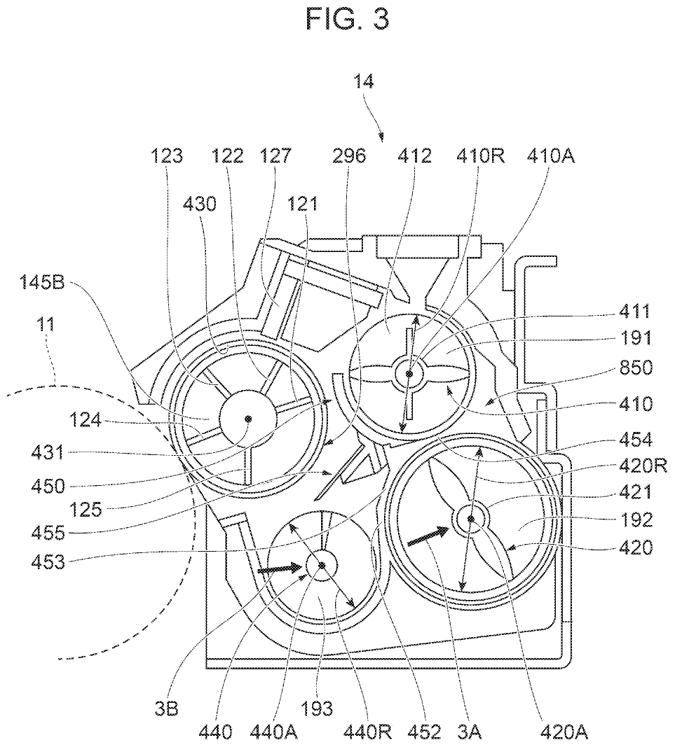

FIG. 3 is a sectional view of the developing device 14 along line III-III in FIG. 2. FIG. 3 illustrates a state of a cross-section at a central portion of the developing device 14 in the longitudinal direction.

The developing device 14 is provided with a one-direction movement path 191 through which a developer passes when moving in one direction.

The developing device 14 is also provided with an opposite-direction movement path 192 through which the developer passes when moving in a direction opposite to the one direction. The opposite-direction movement path 192 is disposed below the one-direction movement path 191.

In the one-direction movement path 191, the developer moves in a direction perpendicular to the sheet of FIG. 3 and in the rearward direction in FIG. 3. In the opposite-direction movement path 192, the developer moves in the direction perpendicular to the sheet of FIG. 3 and in the forward direction in FIG. 3.

The one-direction movement path 191 is provided with a one-direction transport member 410 that transports the developer. In the present exemplary embodiment, the one-direction transport member 410 rotates about a rotary shaft 411 extending along the one-direction movement path 191, thereby moving the developer in the rearward direction.

More specifically, in the present exemplary embodiment, the one-direction transport member 410 receives the driving force transmitted from the aforementioned driving-force receiver 143 (refer to FIG. 2) and rotates to thereby move the developer in the rearward direction.

In the present exemplary embodiment, the developer is transported in the rearward direction, which is the one direction, by the one-direction transport member 410. The one-direction transport member 410 is a rotary member that rotates about an axial center 410A extending in the one direction.

The opposite-direction movement path 192 is provided with an opposite-direction transport member 420 that transports the developer. The opposite-direction transport member 420 is disposed below the one-direction transport member 410.

In the present exemplary embodiment, the opposite-direction transport member 420 rotates about a rotary shaft 421 extending along the opposite-direction movement path 192, thereby moving the developer in the forward direction.

More specifically, the opposite-direction transport member 420 receives the driving force transmitted from the aforementioned driving-force receiver 143 and rotates to thereby move the developer in the forward direction.

In the present exemplary embodiment, the developer is transported in the direction opposite to the aforementioned one direction by the opposite-direction transport member 420.

On the left side of the one-direction transport member 410, there is provided a facing member 430 that is disposed at a location facing the photoconductor drum 11, which is an example of the image carrier.

The facing member 430 supplies the photoconductor drum 11 with the developer supplied from the one-direction transport member 410. When supplied with the developer from the one-direction transport member 410, the facing member 430 supplies the developer to the photoconductor drum 11.

The facing member 430 is formed by a cylindrical body. The facing member 430 is made of, for example, metal such as SUS.

The facing member 430 receives the driving force transmitted from the driving-force receiver 143 and rotates about an axial center 431 in a counterclockwise direction in FIG. 3, thereby causing the developer supplied from the one-direction transport member 410 and adhering to the outer peripheral surface of the facing member 430 to move to the photoconductor drum 11.

Consequently, the developer is supplied to the photoconductor drum 11, and the toner contained in the developer adheres to the surface of the photoconductor drum 11.

In the present exemplary embodiment, the facing member 430 and the one-direction transport member 410 are provided such that the axial center 410A of the one-direction transport member 410 is located above the axial center 431 of the facing member 430.

The facing member 430 is a rotary member that rotates about the axial center 431 extending in the aforementioned one direction. The one-direction transport member 410 is also a rotary member that rotates about the axial center 410A extending in the aforementioned one direction.

In the present exemplary embodiment, there is further provided a first movement restricting portion 450 that is disposed between the facing member 430 and the one-direction transport member 410 and that restricts the movement of part of the developer trying to move from the one-direction transport member 410 to the facing member 430.

In the present exemplary embodiment, of the developer present on the one-direction movement path 191, a developer that has moved over the first movement restricting portion 450 is supplied to the facing member 430.

In the present exemplary embodiment, a lower transport member 440 that is disposed below the facing member 430 is further provided. The lower transport member 440 is a rotary member that rotates about an axial center 440A extending in the aforementioned one direction.

The lower transport member 440 is disposed closer than the opposite-direction transport member 420 to the photoconductor drum 11.

The lower transport member 440 and the opposite-direction transport member 420 are disposed to extend in the aforementioned one direction and disposed in a state in which the positions thereof in the horizontal direction are displaced from each other.

The lower transport member 440 transports the developer that has separated from the facing member 430 in the direction perpendicular to the sheet of FIG. 3 and in the rearward direction in FIG. 3.

The lower transport member 440 transports the developer that has separated from the facing member 430 in the aforementioned one direction so that the developer is supplied (details will be described later) to the one end portion side of the opposite-direction transport member 420.

The lower transport member 440 is rotated by the driving force transmitted from the driving-force receiver 143 and transports the developer that has separated from the facing member 430 in the direction perpendicular to the sheet of FIG. 3 and in the rearward direction in FIG. 3.

The lower transport member 440 is provided on a downward movement path 193 that is disposed closer than the opposite-direction movement path 192 to the photoconductor drum 11.

The downward movement path 193 is disposed to extend in the direction perpendicular to the sheet of FIG. 3 and is disposed below the facing member 430. In the present exemplary embodiment, the developer that has separated from the facing member 430 moves through the downward movement path 193.

In the present exemplary embodiment, there is further provided a second movement restricting portion 452 that is disposed between the lower transport member 440 and the opposite-direction transport member 420 and that restricts the movement of the developer from the opposite-direction transport member 420 to the lower transport member 440.

In addition, in the present exemplary embodiment, there is provided a third movement restricting portion 453 that is disposed between the facing member 430 and the opposite-direction transport member 420 and that restricts the movement of the developer from the opposite-direction transport member 420 to the facing member 430.

In the present exemplary embodiment, there is also provided a fourth movement restricting portion 454 that is disposed between the one-direction transport member 410 and the opposite-direction transport member 420 and that restricts the movement of the developer from the one-direction transport member 410 to the opposite-direction transport member 420 and the movement of the developer from the opposite-direction transport member 420 to the one-direction transport member 410.

In the present exemplary embodiment, the second movement restricting portion 452 to the fourth movement restricting portion 454 are integrated together. The second movement restricting portion 452 to the fourth movement restricting portion 454 are formed by one common component.

In the present exemplary embodiment, there is further provided a fifth movement restricting portion 455 that is disposed between the facing member 430 and the lower transport member 440 and that restricts the movement of the developer from the lower transport member 440 to the facing member 430.

In addition, in the present exemplary embodiment, a magnetic roller 145B is provided inside the facing member 430.

The magnetic roller 145B is provided with five magnetic poles 121 to 125 that are arranged side by side in the circumferential direction of the magnetic roller 145B.

The magnetic pole 121 is a pickup pole and attracts the developer supplied from the one-direction movement path 191. Consequently, the developer adheres to the surface of the facing member 430.

The magnetic poles 122 to 124 serve as transport poles and move the developer on the surface of the facing member 430 to the downstream side in the rotation direction of the facing member 430.

On the downstream side of the magnetic pole 122 and on the upstream side of the magnetic pole 123 in the rotation direction of the facing member 430, a facing restriction portion 127 is provided at a location facing the outer peripheral surface of the facing member 430.

The facing restriction portion 127 is disposed with a gap between the facing restriction portion 127 and the facing member 430.

The facing restriction portion 127 restricts the movement of part of the developer adhering to the surface of the facing member 430 and causes the thickness of the developer adhering to the surface of the facing member 430 to be a predetermined thickness.

In other words, the facing restriction portion 127 restricts the movement of part of the developer that adheres to the outer peripheral surface of the facing member 430 and that moves toward the photoconductor drum 11 with the rotation of the facing member 430.

When the developer on the surface of the facing member 430 moves to the downstream side in the rotation direction of the facing member 430, the developer moves to the surface of the photoconductor drum 11, as an example of the image carrier, and the toner contained in the developer adheres to the photoconductor drum 11.

Development is thereby performed, and an image that is formed with the toner is formed on the surface of the photoconductor drum 11.

The image is in a state of being temporarily held by the photoconductor drum 11 and is moved to the first transfer portion 10 (refer to FIG. 1) by the photoconductor drum 11 that rotates. Then, the image is transferred to the intermediate transfer belt 15.

The magnetic pole 125 serves as a pickoff pole, and the magnetic pole 125 forms a repulsive magnetic field and causes the developer adhering to the surface of the facing member 430 to separate from the facing member 430. The magnetic pole 125 causes the developer that has not been transferred to the photoconductor drum 11 and that remains on the surface of the facing member 430 to separate from the facing member 430.

In the configuration according to the present exemplary embodiment, separation of the developer occurs at a separation portion 296.

In the present exemplary embodiment, the separation portion 296 is located at the front of the magnetic pole 121 that serves as the pickup pole, and separation of the developer occurs on the front side of the magnetic pole 121 in the present exemplary embodiment.

The developer that has separated from the facing member 430 moves downward and reaches the downward movement path 193.

The developer that has reached the downward movement path 193 is moved by the lower transport member 440 to the one end portion 141 (refer to FIG. 2) side of the developing device 14 and is then moved (details will be described later) to the opposite-direction movement path 192 (refer to FIG. 3).

The one-direction transport member 410 (refer to FIG. 3), the opposite-direction transport member 420, the facing member 430, the magnetic roller 145B, and the lower transport member 440 extend in the direction perpendicular to the sheet of FIG. 3 and are disposed to have a relationship of being parallel to each other.

The one-direction transport member 410 includes the rotary shaft 411 extending in the longitudinal direction of the developing device 14, and a protrusion 412 protruding from the outer peripheral surface of the rotary shaft 411.

The protrusion 412 is provided to extend from one end portion to the other end portion in the axial direction of the rotary shaft 411 and provided in a helical form. In other words, the protrusion 412 is provided in a screw form.

In the present exemplary embodiment, when the rotary shaft 411 provided at the one-direction transport member 410 rotates, the protrusion 412 presses the developer in the axial direction of the rotary shaft 411, and the developer is thereby moved in a direction in which the rotary shaft 411 extends.

The opposite-direction transport member 420 and the lower transport member 440 each have the same configuration as the configuration of the one-direction transport member 410, and the opposite-direction transport member 420 and the lower transport member 440 are also each provided with a rotary shaft extending in the longitudinal direction of the developing device 14 and a helical protrusion.

The one-direction transport member 410, the opposite-direction transport member 420, the facing member 430, and the lower transport member 440 are each a rotary member that rotates about an axial center extending in the aforementioned one direction.

In the present exemplary embodiment, an axial center 420A of the opposite-direction transport member 420 is located farther than the axial center 410A of the one-direction transport member 410 from the facing member 430 when the axial center 420A and the axial center 410A are compared with each other in terms of positions in the horizontal direction.

In the present exemplary embodiment, the axial center 420A of the opposite-direction transport member 420 is located off a portion that is immediately under the axial center 410A of the one-direction transport member 410.

In this case, compared with when the axial center 420A of the opposite-direction transport member 420 is located immediately under the axial center 410A of the one-direction transport member 410, a size reduction of the developing device 14 in the height direction of the developing device 14 may be addressed.

When the axial center 420A of the opposite-direction transport member 420 is located off the portion immediately under the axial center 410A of the one-direction transport member 410, it may be possible to move the opposite-direction transport member 420 obliquely upward, as indicated by the arrow 3A in FIG. 3, while maintaining a clearance between the one-direction transport member 410 and the opposite-direction transport member 420 in a case where the axial center 420A is located immediately under the axial center 410A.

In this case, compared with when the axial center 420A of the opposite-direction transport member 420 is located immediately under the axial center 410A of the one-direction transport member 410, a size reduction of the developing device 14 in the height direction of the developing device 14 may be addressed.

Further, as in the present exemplary embodiment, when the axial center 420A of the opposite-direction transport member 420 is located off the portion immediately under the axial center 410A of the one-direction transport member 410 and when the axial center 420A of the opposite-direction transport member 420 is located farther than the axial center 410A of the one-direction transport member 410 from the facing member 430, it may be possible to dispose the lower transport member 440 to be away from the facing member 430.

When the lower transport member 440 is disposed away from the facing member 430 and the value of a clearance between the facing member 430 and the lower transport member 440 is increased, the developer that has separated from the facing member 430 and moved to the lower transport member 440 may be caused not to return to the facing member 430 easily.

When, as in the present exemplary embodiment, the axial center 420A of the opposite-direction transport member 420 is located farther than the axial center 410A of the one-direction transport member 410 from the facing member 430, the lower transport member 440 may be easily disposed, instead of at a portion immediately under the facing member 430, off the portion immediately under the facing member 430, as indicated by the arrow 3B.

In this case, the clearance between the facing member 430 and the lower transport member 440 increases, and the developer that has separated from the facing member 430 and moved to the lower transport member 440 may be caused not to return to the facing member 430 easily.

In the present exemplary embodiment, the axial center 440A of the lower transport member 440 is located off a portion that is immediately under the axial center 431 of the facing member 430.

More specifically, the axial center 440A of the lower transport member 440 is located closer than the axial center 431 of the facing member 430 to the opposite-direction transport member 420 in the present exemplary embodiment when the axial center 440A and the axial center 431 are compared with each other in terms of positions in the horizontal direction.

In this case, as described above, the clearance between the facing member 430 and the lower transport member 440 increases, and the developer that has separated from the facing member 430 and moved to the lower transport member 440 may be caused not to return to the facing member 430 easily.

Further, the axial center 440A of the lower transport member 440 is located below the axial center 420A of the opposite-direction transport member 420 in the present exemplary embodiment when the axial center 440A and the axial center 420A are compared with each other in terms of positions in the vertical direction.

In this case, compared with when the position of the axial center 440A of the lower transport member 440 in the vertical direction is the same as the position of the axial center 420A of the opposite-direction transport member 420 in the vertical direction, the clearance between the facing member 430 and the lower transport member 440 increases.

When the clearance between the facing member 430 and the lower transport member 440 increases, the developer that has separated from the facing member 430 and moved to the lower transport member 440 may be caused not to return to the facing member 430 easily.

Further, in the present exemplary embodiment, an outer diameter 440R of the lower transport member 440 is smaller than an outer diameter 410R of the one-direction transport member 410. In addition, in the present exemplary embodiment, the number of rotation of the lower transport member 440 is more than or equal to the number of rotation of the one-direction transport member 410.

In the present exemplary embodiment, the outer diameter 440R of the lower transport member 440 is smaller than the outer diameter 410R of the one-direction transport member 410 and is smaller than an outer diameter 420R of the opposite-direction transport member 420.

In this case, when the amount of the developer that is transported is considered only from the point of view of the outer diameters, the amount of the developer transported per unit time by the lower transport member 440 is smaller than the amount of the developer transported per unit time by the one-direction transport member 410 and is smaller than the amount of the developer transported per unit time by the opposite-direction transport member 420.

When the amount of the developer transported by the lower transport member 440 is small, the amount of the developer transported by the lower transport member 440 is smaller than the amount of the developer supplied from the one-direction transport member 410 to the lower transport member 440 via the facing member 430, which may cause the developer to accumulate at a location where the lower transport member 440 is installed.

When the developer accumulates at the location where the lower transport member 440 is installed, the upper surface of the accumulated developer becomes close to the facing member 430, and a malfunction in which the developer adheres again to the facing member 430 may easily occur.

When the developer after separated from the facing member 430 adheres again to the facing member 430 without passing through the opposite-direction transport member 420 and the one-direction transport member 410 and moves to the photoconductor drum 11, deterioration in the quality of an image to be formed on the photoconductor drum 11 may be caused.

In contrast, when the number of rotation of the lower transport member 440 is more than or equal to the number of rotation of the one-direction transport member 410, as in the present exemplary embodiment, the developer may be caused not to accumulate easily at the location where the lower transport member 440 is installed.

In this case, occurrence of a situation in which the developer after separated from the facing member 430 is supplied to the photoconductor drum 11 without passing through the opposite-direction transport member 420 and the one-direction transport member 410 may be suppressed.

The number of rotation of the lower transport member 440 may be preferably set to twice or less the number of rotation of the one-direction transport member 410.

When the number of rotation of the lower transport member 440 is set to twice or less the number of rotation of the one-direction transport member 410, generation of frictional heat and the like due to that the number of rotation of the lower transport member 440 is large may be easily suppressed.

When, as in the present exemplary embodiment, the outer diameter 440R of the lower transport member 440 is set to be smaller than the outer diameter 410R of the one-direction transport member 410, the outer diameter 440R of the lower transport member 440 may be preferably set to be more than or equal to a value that is obtained by multiplying the outer diameter 410R of the one-direction transport member 410 by 0.85.

When the outer diameter 440R of the lower transport member 440 is smaller than the value that is obtained by multiplying the outer diameter 410R of the one-direction transport member 410 by 0.85, the aforementioned accumulation may easily occur even when the rotational speed of the lower transport member 440 is increased.

Therefore, the outer diameter 440R of the lower transport member 440 may be preferably set to be more than or equal to the value that is obtained by multiplying the outer diameter 410R of the one-direction transport member 410 by 0.85.

Alternatively, the outer diameter 440R of the lower transport member 440 may be set to be larger than the outer diameter 410R of the one-direction transport member 410.

In this case, however, it is preferable to set the outer diameter 440R of the lower transport member 440 to be less than or equal to a value that is obtained by multiplying the outer diameter 410R of the one-direction transport member 410 by 1.15.

By increasing the outer diameter 440R of the lower transport member 440, suppression of the aforementioned accumulation may be addressed. Meanwhile, if the outer diameter 440R of the lower transport member 440 is set to be larger than the value that is obtained by multiplying the outer diameter 410R of the one-direction transport member 410 by 1.15, an effect of suppressing the accumulation decreases.

In addition to a decrease in the effect of suppressing the accumulation, a size increase of the developing device 14 may also easily occur if the outer diameter 440R of the lower transport member 440 is set to be larger than the value that is obtained by multiplying the outer diameter 410R of the one-direction transport member 410 by 1.15.

Therefore, when the outer diameter 440R of the lower transport member 440 is set to be larger than the outer diameter 410R of the one-direction transport member 410, it may be preferable to set the outer diameter 440R of the lower transport member 440 to be less than or equal to the value that is obtained by multiplying the outer diameter 410R of the one-direction transport member 410 by 1.15.

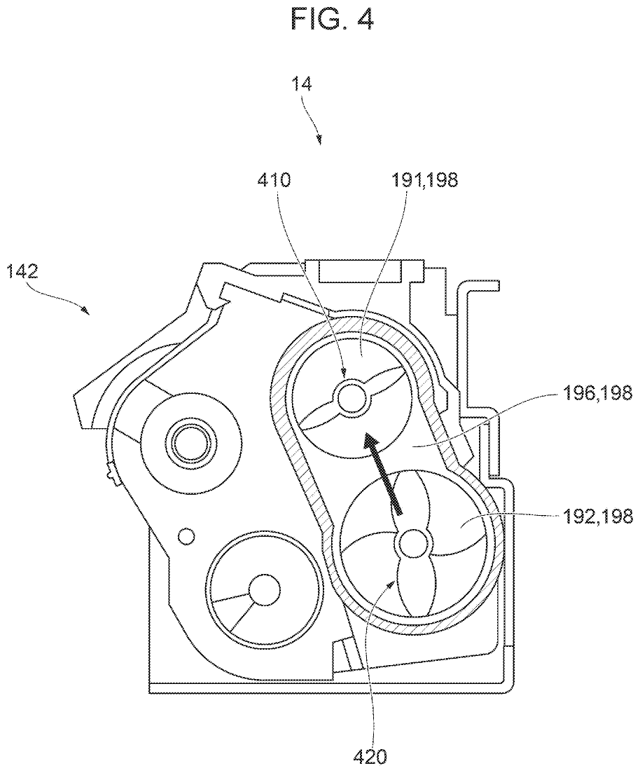

FIG. 4 is a sectional view of the developing device 14 along line IV-IV in FIG. 2.

FIG. 4 illustrates a state of a cross-section at the other end portion 142 of the developing device 14.

In the present exemplary embodiment, as illustrated in FIG. 4, the other end portion 142 of the developing device 14 is provided with an upward movement path 196 that is disposed to extend in the up-down direction.

In the present exemplary embodiment, the developer that has moved through the opposite-direction movement path 192 passes through the upward movement path 196 and moves toward the one-direction movement path 191.

The developing device 14 according to the present exemplary embodiment has a configuration provided with the upward movement path 196 as an example of a second movement path through which the developer that moves from the opposite-direction transport member 420 toward the one-direction transport member 410 passes.

Here, the state described as “disposed to extend in the up-down direction” is not limited to a state in which the upward movement path 196 extends in the vertical direction and includes a state in which the upward movement path 196 is disposed in a state of being inclined with respect to the vertical direction.

In the present exemplary embodiment, when the developer is transported to the other end portion 142 of the developing device 14 by the opposite-direction transport member 420, the developer accumulates below the upward movement path 196, and the developer gradually moves upward inside the upward movement path 196.

Consequently, the developer is supplied to the one-direction transport member 410. The developer that has moved through the upward movement path 196 is transported along the one-direction movement path 191 toward the one end portion 141 (refer to FIG. 2) of the developing device 14 by the one-direction transport member 410.

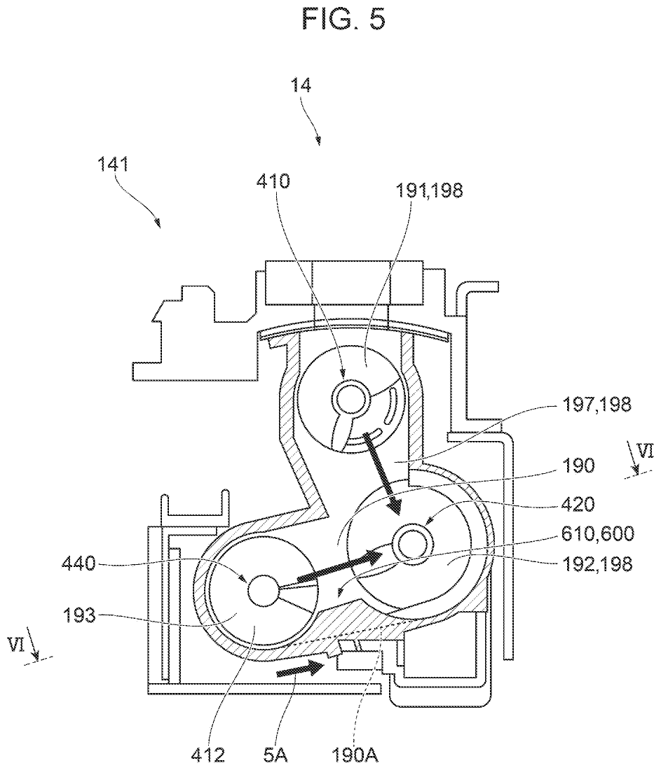

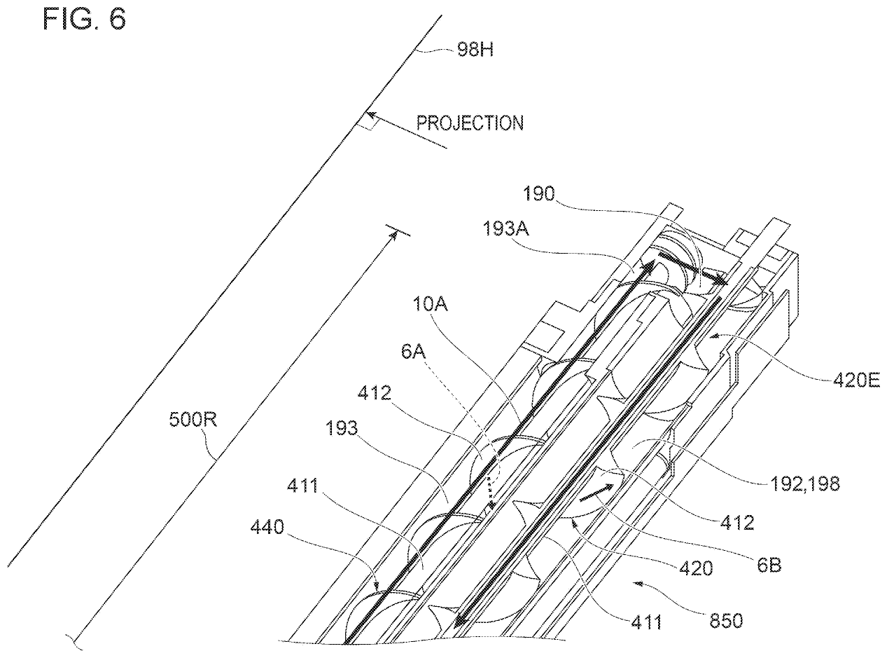

FIG. 5 is a sectional view of the developing device 14 along line V-V in FIG. 2. FIG. 6 is a sectional view of the developing device 14 along line VI-VI in FIG. 5.

FIG. 5 illustrates a state of a cross-section at the one end portion 141 of the developing device 14.

In the present exemplary embodiment, as illustrated in FIG. 5, the one end portion 141 of the developing device 14 is provided with a downward movement path 197 that is disposed to extend in the up-down direction.

Similarly to the above, the state described as “disposed to extend in the up-down direction” is not limited to a state in which the downward movement path 197 extends in the vertical direction and includes a state in which the downward movement path 197 is in a state of being inclined with respect to the vertical direction.

In the present exemplary embodiment, the developer that has moved through the one-direction movement path 191 passes through the downward movement path 197 and moves toward the opposite-direction movement path 192.

In the present exemplary embodiment, the downward movement path 197 is provided as an example of a first movement path through which the developer that moves from the one-direction transport member 410 toward the opposite-direction transport member 420 passes.

In the present exemplary embodiment, the developer that has moved through the one-direction movement path 191 passes through the downward movement path 197 and moves toward the opposite-direction movement path 192. Next, the developer passes through the opposite-direction movement path 192 and moves toward the other end portion 142 (refer to FIG. 2) of the developing device 14.

The developing device 14 according to the present exemplary embodiment has a configuration provided with an annular developer movement path 198 that is formed by four paths including the one-direction movement path 191, the downward movement path 197, the opposite-direction movement path 192, and the upward movement path 196 (refer to FIG. 4).

In the present exemplary embodiment, the developer circularly moves along the annular developer movement path 198.

Further, in the present exemplary embodiment, as illustrated in FIG. 5, there is provided a connection path 190 that extends in a lateral direction and that connects the downward movement path 193 and the opposite-direction movement path 192 to each other.

In the present exemplary embodiment, the connection path 190 is provided as a movement path for the developer that moves from the lower transport member 440 toward the opposite-direction transport member 420.

The connection path 190 is disposed in a state of being inclined to extend upward obliquely. In other words, the connection path 190 is disposed in a state of being inclined with respect to both the horizontal direction and the vertical direction.

In the present exemplary embodiment, the developer that has moved along the downward movement path 193 by the lower transport member 440 passes through the connection path 190 and moves to the opposite-direction movement path 192.

In the present exemplary embodiment, by being pressed by the developer that is transported sequentially from the upstream side, the developer that has accumulated at, of the downward movement path 193, an end portion located on the downstream side in the movement direction of the developer passes through the connection path 190 and moves to the opposite-direction movement path 192.

As described above, the developing device 14 according to the present exemplary embodiment is provided with the annular developer movement path 198, and the developer is stirred as a result of the developer moving through the annular developer movement path 198.

Further, in the present exemplary embodiment, when the developer that is stirred passes through the one-direction movement path 191 (refer to FIG. 3), part of the developer moves over the first movement restricting portion 450 and is supplied to the facing member 430, and the developer adheres to the surface of the facing member 430.

The developer adhering to the surface of the facing member 430 moves with the rotation of the facing member 430 to a location facing the photoconductor drum 11, and the developer is thereby supplied to the photoconductor drum 11.

In the developer adhering to the surface of the facing member 430, a developer that has not been supplied to the photoconductor drum 11 passes through a location facing the magnetic pole 125 (refer to FIG. 3) serving as the pickoff pole and, when reached the separation portion 296, separates from the facing member 430 and moves downward.

The developer that has moved downward reaches the downward movement path 193 where the lower transport member 440 is provided.

The developer that has reached the downward movement path 193 passes, as illustrated in FIG. 6, through the downward movement path 193 and reaches, of the downward movement path 193, an end portion 193A located on the downstream side in the movement direction of the developer.

Thereafter, the developer passes through the connection path 190 and moves to the opposite-direction movement path 192 by being pressed by the developer that is sequentially transported from the upstream side.

When the developer moves to the opposite-direction movement path 192, the developer moves again along the annular developer movement path 198.

In the present exemplary embodiment, as illustrated in FIG. 5, there is provided a suppressing portion 600 that suppresses returning of the developer that has moved to the opposite-direction transport member 420 toward the lower transport member 440 through the connection path 190.

Specifically, in the present exemplary embodiment, there is provided, as the suppressing portion 600, a projection 610 projecting upward from a lower surface 190A of the connection path 190.

In the present exemplary embodiment, the lower surface 190A that is located at the side of the connection path 190 and directed upward to face the connection path 190 is provided, and the projection 610 that projects upward from the lower surface 190A is provided in the present exemplary embodiment.

Consequently, in the present exemplary embodiment, the developer that has moved to the opposite-direction transport member 420 side may be caused not to return to the lower transport member 440 easily.

When the developer that has moved to the opposite-direction transport member 420 side easily returns to the lower transport member 440, the developer tends to accumulate at the location where the lower transport member 440 is installed. In this case, as described above, the upper surface of the accumulated developer becomes close to the facing member 430 and may easily cause a malfunction in which, for example, the developer adheres again to the facing member 430.

When, as in the present exemplary embodiment, the suppressing portion 600 that suppresses returning of the developer toward the lower transport member 440 is provided, accumulation of the developer at the location where the lower transport member 440 is installed may be suppressed, which suppresses occurrence of a malfunction in which, for example, the developer adheres again to the facing member 430.

Further, in the present exemplary embodiment, the developer moves in the downward movement path 193, through which the developer transported by the lower transport member 440 moves, while being gathered as indicated by the arrow 5A on the side where the opposite-direction transport member 420 is located.

Specifically, due to the inclination of the protrusion 412 provided in a helical form, the developer transported by the lower transport member 440 in the present exemplary embodiment moves as indicated by the arrow 6A in FIG. 6 to the upstream side obliquely and to the side where the opposite-direction transport member 420 is located while moving toward the downstream side in the transport direction of the developer.

Consequently, in the present exemplary embodiment, the developer moves while being gathered on the side where the opposite-direction transport member 420 is located.

More specifically, in the developer, a developer located below the rotary shaft 411 of the lower transport member 440 (refer to FIG. 6) moves as indicated by the arrow 6A in FIG. 6 to the upstream side obliquely and to the side where the opposite-direction transport member 420 is located in the present exemplary embodiment while moving toward the downstream side in the transport direction of the developer.

Consequently, in the downward movement path 193, through which the developer transported by the lower transport member 440 moves, the developer moves while being gathered on the side where the opposite-direction transport member 420 is located.

Since, as described above, the protrusion 412 provided at the lower transport member 440 is formed in a helical form, the developer that is pressed by the protrusion 412 moves along the surface of the protrusion 412 while moving toward the downstream side in the transport direction of the developer and moves to the upstream side in an oblique direction.

More specifically, the developer that is pressed by, of the protrusion 412, a portion located on the lower side of the rotary shaft 411 moves along the surface of the protrusion 412 while moving toward the downstream side in the transport direction of the developer and moves to the upstream side and to the side where the opposite-direction transport member 420 is located.

Consequently, the developer that is pressed by, of the protrusion 412, the portion located on the lower side of the rotary shaft 411 moves while being gathered on the side where the opposite-direction transport member 420 is located.

Meanwhile, the developer that is pressed by, of the protrusion 412, a portion located on the upper side of the rotary shaft 411 moves to the side opposite to the side where the opposite-direction transport member 420 is located while moving toward the downstream side in the transport direction of the developer.

Here, due to the gravity, the developer normally accumulates at the bottom of the downward movement path 193 where the lower transport member 440 is provided, and the amount of the developer that is pressed by the portion of the protrusion 412 located on the lower side of the rotary shaft 411 is larger than the amount of the developer that is pressed by the portion of the protrusion 412 located on the upper side of the rotary shaft 411.

In this case, the amount of the developer that moves while being gathered on the side where the opposite-direction transport member 420 is located is larger than the amount of the developer that moves while being gathered on the side opposite to the side where the opposite-direction transport member 420 is located.

In this case, as the entirety of the developer inside the downward movement path 193 where the lower transport member 440 is provided, the developer moves to the downstream side while being gathered on the side where the opposite-direction transport member 420 is located.

Further, in the present exemplary embodiment, the opposite-direction movement path 192, through which the developer transported by the opposite-direction transport member 420 moves, has a configuration in which the developer moves to the downstream side while being gathered on the side opposite to the side where the lower transport member 440 is located.

Specifically, in the configuration according to the present exemplary embodiment, the developer that is pressed by, of the protrusion 412, the portion located on the lower side of the rotary shaft 411 moves to the downstream side while being gathered in the direction indicated by the arrow 6B in FIG. 6.

Similarly to the above, the developer that is pressed by, of the protrusion 412 provided at the opposite-direction transport member 420, the portion located on the upper side of the rotary shaft 411 is gathered on the side where the lower transport member 440 is located while moving toward the downstream side in the transport direction of the developer.

Similarly to the above, as the entirety of the developer inside the opposite-direction movement path 192 where the opposite-direction transport member 420 is provided, the developer moves to the downstream side while being gathered on the side opposite to the side where the lower transport member 440 is located.

In a configuration in which, as in the present exemplary embodiment, the developer moves, at the location where the lower transport member 440 is installed, to the downstream side while being gathered on the side where the opposite-direction transport member 420 is located, the developer may easily move toward the opposite-direction transport member 420 when reached the connection path 190.

When the developer easily moves toward the opposite-direction transport member 420, occurrence of accumulation of the developer at the location where the lower transport member 440 is installed may be suppressed.

In addition, in a configuration in which, as in the present exemplary embodiment, the developer moves, at a location where the opposite-direction transport member 420 is installed, to the downstream side while being gathered on the side opposite to the side where the lower transport member 440 is located, occurrence of returning of the developer to the lower transport member 440 may be suppressed.

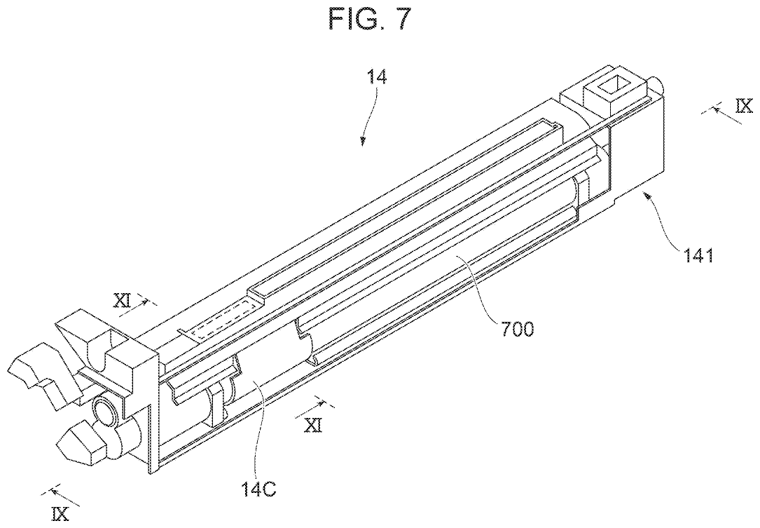

FIG. 7 is a perspective view of the developing device 14 as viewed obliquely from above.

In the present exemplary embodiment, as illustrated in FIG. 7, the developing device 14 is provided with a metal pipe 700 that extends in the longitudinal direction of the developing device 14. In the present exemplary embodiment, the metal pipe 700 is used to accelerate heat dissipation from the developing device 14.

In the present exemplary embodiment, the aforementioned opposite-direction movement path 192 (refer to FIG. 3) is provided inside the pipe 700. In the present exemplary embodiment, the opposite-direction transport member 420 (refer to FIG. 3) is housed in the pipe 700.

In the present exemplary embodiment, as described with FIG. 3, the fourth movement restricting portion 454 that restricts the movement of the developer between the one-direction movement path 191 and the opposite-direction movement path 192 is provided between the one-direction movement path 191 and the opposite-direction movement path 192, and a portion of the fourth movement restricting portion 454 is formed by the pipe 700.

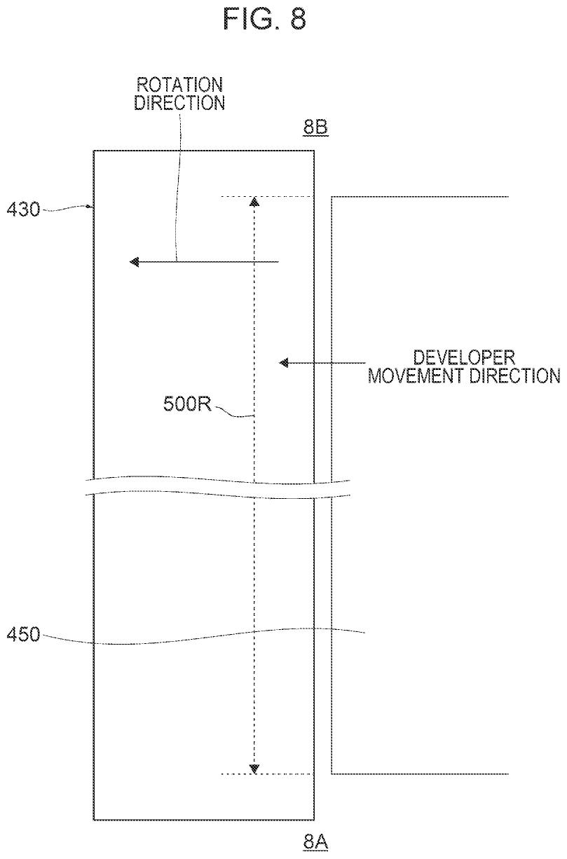

FIG. 8 is a perspective view of the facing member 430 as viewed from above.

In the present exemplary embodiment, a developer adhesion region 500R that is a region included in the facing member 430 and to which the developer adheres is previously determined, and the developer from the one-direction transport member 410 (not illustrated in FIG. 8) adheres to a portion in the developer adhesion region 500R in the present exemplary embodiment.

In the present exemplary embodiment, the first movement restricting portion 450 illustrated in FIG. 3 is provided at a location facing the developer adhesion region 500R, and the developer from the one-direction transport member 410 moves over the first movement restricting portion 450 and adheres to the developer adhesion region 500R.

At a location, which is a location off the developer adhesion region 500R, indicated by the sign 8A, the developing device 14 has the configuration illustrated in FIG. 4. In addition, at a location, which is a location off the developer adhesion region 500R, indicated by the sign 8B, the developing device 14 has the configuration illustrated in FIG. 5.

In this case, at the locations, which are locations off the developer adhesion region 500R, indicated by the signs 8A and 8B, the developer does not adhere to the facing member 430.

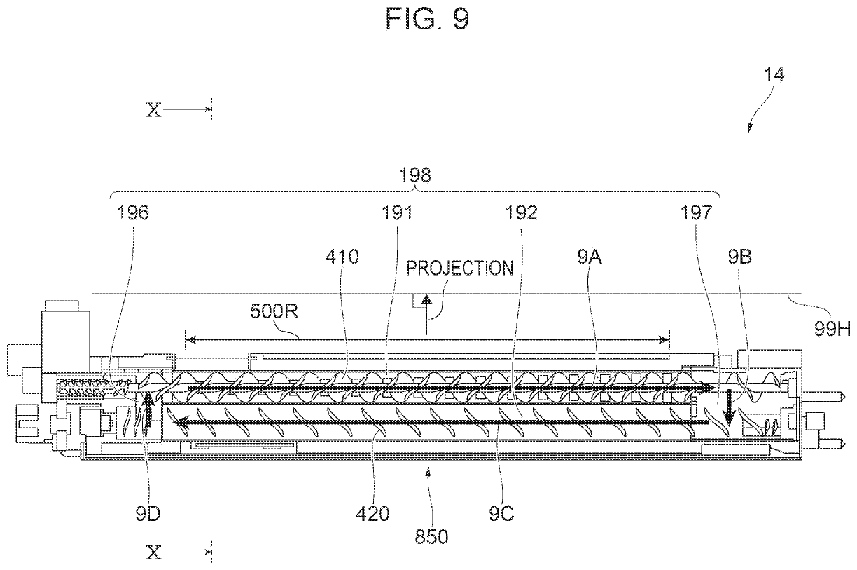

FIG. 9 is a sectional view of the developing device 14 along line IX-IX in FIG. 7.

FIG. 9 illustrates a state of a cross-section at a plane passing through both the opposite-direction movement path 192 and the one-direction movement path 191.

As illustrated in FIG. 9 and as described above, there is provided in the present exemplary embodiment the annular developer movement path 198 including the one-direction movement path 191, the downward movement path 197, the opposite-direction movement path 192, and the upward movement path 196.

In the present exemplary embodiment, there is provided a developer moving unit that moves the developer along the developer movement path 198, and the developer is circularly moved by the developer moving unit.

In the present exemplary embodiment, the developer moving unit that circularly moves the developer includes the one-direction transport member 410, the opposite-direction transport member 420, the driving source that rotates these transport members, the one-direction movement path 191, the downward movement path 197, the opposite-direction movement path 192, the upward movement path 196, and the like.

In the one-direction movement path 191, the downward movement path 197, the opposite-direction movement path 192, and the upward movement path 196, the developer moves in the directions indicated by the arrow 9A, the arrow 9B, the arrow 9C, and the arrow 9D, respectively.

In the one-direction movement path 191, as indicated by the arrow 9A in FIG. 9, the developer passes through the one-direction movement path 191 and moves toward the side where the downward movement path 197 is provided.

Then, as indicated by the arrow 9B, the developer passes through the downward movement path 197 and moves toward the opposite-direction movement path 192.

Thereafter, as indicated by the arrow 9C, the developer passes through the opposite-direction movement path 192 and moves toward the side where the upward movement path 196 is provided.

Next, as indicated by the arrow 9D, the developer passes through the upward movement path 196 and moves toward the one-direction movement path 191.

In the present exemplary embodiment, the one-direction transport member 410, the opposite-direction transport member 420, the driving source that rotates these transport members, the one-direction movement path 191, the downward movement path 197, the opposite-direction movement path 192, the upward movement path 196, and the like may be considered as a supplying mechanism 850 that supplies the developer to the facing member 430 (refer to FIG. 3).

The supplying mechanism 850, as an example of a supplying unit, has a function of stirring the developer and supplies the stirred developer to the facing member 430.

The supplying mechanism 850 circularly moves and thereby stirs the developer and supplies the stirred developer to the facing member 430.

The supplying mechanism 850 sends the developer to the one-direction transport member 410 and rotates the one-direction transport member 410, thereby supplying the developer to the facing member 430 by using the one-direction transport member 410.

As described above, the one-direction transport member 410 is provided with the helical protrusion 412. At the location where the one-direction transport member 410 is installed, the developer that is moved to the upstream side obliquely by being pressed by the protrusion 412 moves to the facing member 430 side.

In other words, at the location where the one-direction transport member 410 is installed, the developer moves to the downstream side while being gathered on the facing member 430 side.

Consequently, in the present exemplary embodiment, the developer transported by the one-direction transport member 410 moves toward the facing member 430 side and is supplied to the facing member 430. More specifically, the developer transported by the one-direction transport member 410 moves over the first movement restricting portion 450 (refer to FIG. 8) and is supplied to the facing member 430.

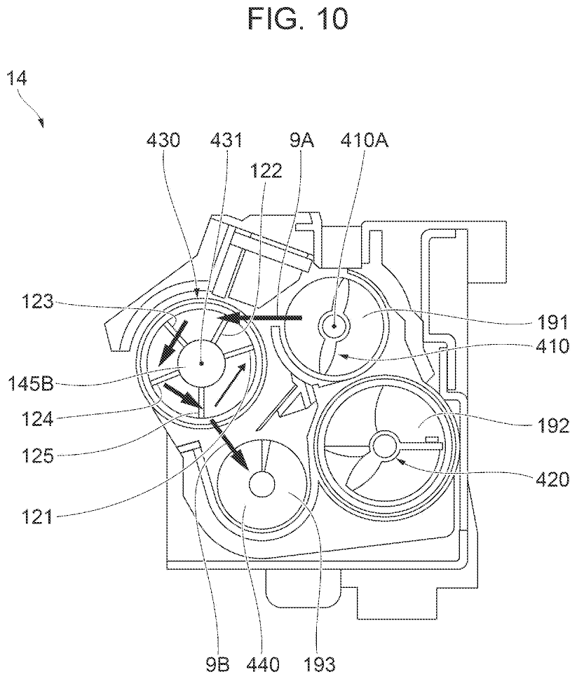

FIG. 10 is a sectional view of the developing device 14 along line X-X in FIG. 9.

In the present exemplary embodiment, the developer that is present on the one-direction movement path 191 moves as indicated by the arrow 9A from the one-direction movement path 191 toward the facing member 430 in the process of moving along the one-direction movement path 191 toward the downstream side.

The developer that is present on the one-direction movement path 191 is, as described above, gathered on the facing member 430 side in the process of moving along the one-direction movement path 191 toward the downstream side, and the developer is thereby supplied to the facing member 430.

In the present exemplary embodiment, as described above, the facing member 430 and the one-direction transport member 410 are provided such that the axial center 410A of the one-direction transport member 410 is located above the axial center 431 of the facing member 430. In this case, a load applied to the developer is small.

Here, for example, it is assumed that the facing member 430 and the one-direction transport member 410 are provided such that the axial center 410A of the one-direction transport member 410 is located below the axial center 431 of the facing member 430.

In this case, the developer first adheres to, of the surface of the facing member 430, a portion that is located on the lower side of the axial center 431. Then, the developer moves to the location facing the photoconductor drum 11.

In this case, compared with when the axial center 410A is located above the axial center 431, the developer adhering to the surface of the facing member 430 moves by a longer distance while receiving an effect of the magnetic poles provided at the magnetic roller 145B. In this case, the load applied to the developer tends to be large.

In contrast, when the axial center 410A of the one-direction transport member 410 is located, as in the present exemplary embodiment, above the axial center 431 of the facing member 430, the developer moves by a shorter distance, and the load applied to the developer is small.

In the present exemplary embodiment, the developer that has passed through the facing member 430 moves as indicated by the arrow 9B to the lower transport member 440. In other words, the developer remaining on the surface of the facing member 430 without being transferred to the photoconductor drum 11 separates from the facing member 430 and moves to the lower transport member 440.

At the location where the lower transport member 440 is installed, the lower transport member 440 transports the developer as indicated by the arrow 10A in FIG. 6, and the developer is transported to the connection path 190.

The developer that has been transported to the connection path 190 passes through the connection path 190 and moves to the opposite-direction movement path 192 provided inside the supplying mechanism 850. Consequently, the developer is supplied to a one end portion 420E of the opposite-direction transport member 420.

The opposite-direction transport member 420 forms a portion of the aforementioned supplying mechanism 850 having the function of stirring the developer.

In the present exemplary embodiment, the developer that has separated from the facing member 430 is transported by the lower transport member 440 to the supplying mechanism 850 having the function of stirring the developer.

Further description will be provided with reference to FIG. 6.

In the present exemplary embodiment, as illustrated in FIG. 6, the connection path 190 is located off the aforementioned developer adhesion region 500R, which is a region included in the facing member 430 and to which the developer adheres, in the axial direction of the facing member 430 (not illustrated in FIG. 6).

In the configuration according to the present exemplary embodiment, the developer adhesion region 500R and the connection path 190 do not overlap each other when the developer adhesion region 500R and the connection path 190 are projected in a direction orthogonal to the axial direction of the facing member 430 and toward an imaginary plane 98H extending in the axial direction of the facing member 430.

Here, at the location where the connection path 190 is installed, the upper surface of the developer tends to rise as a result of accumulation of the developer that is sequentially transported from the upstream side.

In this case, in a configuration in which the connection path 190 is provided in the developer adhesion region 500R, the developer that has accumulated at the location where the connection path 190 is installed moves toward the photoconductor drum 11 via the facing member 430 and easily adheres to the photoconductor drum 11.

In this case, the developer after separating from the facing member 430 adheres to the photoconductor drum 11 without passing through the supplying mechanism 850 having the stirring function, and deterioration in the quality of an image that is to be formed may easily occur.

In contrast, when the connection path 190 is located, as in the present exemplary embodiment, off the developer adhesion region 500R, occurrence of a situation in which the developer that has accumulated at the location where the connection path 190 is installed adheres to the photoconductor drum 11 without passing through the supplying mechanism 850 may be suppressed.

Further, as illustrated in FIG. 9, the downward movement path 197, as an example of the first movement path, is located off the developer adhesion region 500R in the axial direction of the facing member 430 (not illustrated in FIG. 9) in the present exemplary embodiment.

In addition, as illustrated in FIG. 9, the upward movement path 196, as an example of the second movement path, is located off the developer adhesion region 500R in the axial direction of the facing member 430 in the present exemplary embodiment.

Here, it is assumed that the developer adhesion region 500R, the downward movement path 197, and the upward movement path 196 are projected in the direction orthogonal to the axial direction of the facing member 430 and toward an imaginary plane 99H extending in the axial direction of the facing member 430.

In this case, the developer adhesion region 500R and the downward movement path 197 do not overlap each other in the present exemplary embodiment. In addition, the developer adhesion region 500R and the upward movement path 196 also do not overlap each other.

At the locations where the downward movement path 197 and the upward movement path 196 are installed, the upper surface of the developer also tends to rise as a result of accumulation of the developer sequentially transported from the upstream side.

In this case, when the downward movement path 197 and the upward movement path 196 are provided in the developer adhesion region 500R, the developer in the middle of being stirred tends to adhere to the photoconductor drum 11 via the facing member 430.

In contrast, when the downward movement path 197 and the upward movement path 196 are located, as in the present exemplary embodiment, off the developer adhesion region 500R, occurrence of the situation in which the developer in the middle of being stirred adheres to the photoconductor drum 11 may be suppressed.

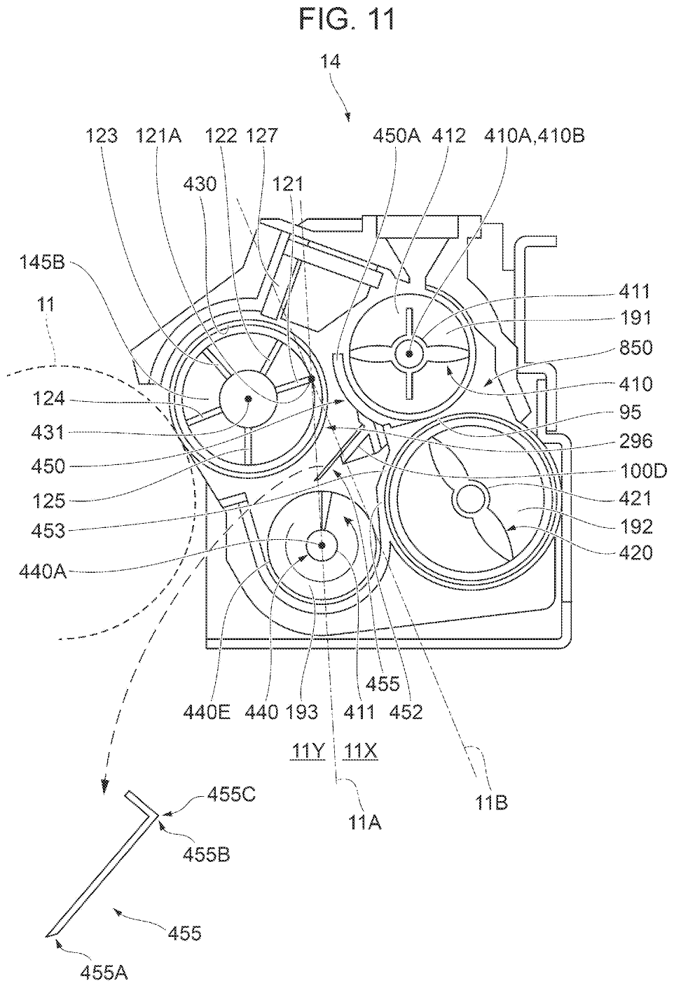

FIG. 11 is a view for illustrating the fifth movement restricting portion 455. FIG. 11 illustrates the same state as the state illustrated in FIG. 3.

As described above, the magnetic roller 145B is provided with the magnetic pole 121 serving as the pickup pole in the present exemplary embodiment. The magnetic pole 121 is an example of an attracting magnetic pole that causes the developer supplied from the supplying mechanism 850 to be attracted onto the outer peripheral surface of the facing member 430. The magnetic pole 121 is provided on the inner side of the facing member 430.

In the present exemplary embodiment, the fifth movement restricting portion 455 is provided between the magnetic pole 121 provided on the inner side of the facing member 430 and the lower transport member 440.

The lower transport member 440 is a member that rotates about the rotary shaft 411 extending in the axial direction of the facing member 430.

Here, it is assumed that a plane 11A is a plane extending along the axial center 440A of the lower transport member 440 and passing through both the magnetic pole 121 and the axial center 440A. Further, it is assumed that the plane 11A is present between two regions 11X and 11Y that face each other.

More specifically, it is assumed that the plane 11A passes through the axial center 440A of the lower transport member 440 and an outer side portion 121A of the magnetic pole 121, the outer side portion 121A being a portion located on the outermost side in the radial direction of the magnetic roller 145B, and assumed that the two regions 11X and 11Y face each other with the plane 11A therebetween.

In the present exemplary embodiment, as the two regions, one region 11X and another region 11Y are present.

In the present exemplary embodiment, the lower transport member 440 rotates such that, of the lower transport member 440, a portion located on the one region 11X side moves toward the facing member 430 and a portion located on the other region 11Y side moves away from the facing member 430.

In the configuration according to the present exemplary embodiment, the fifth movement restricting portion 455 is provided between the attracting magnetic pole 121 and, of the lower transport member 440, a portion located in the one region 11X.

More specifically, in the configuration, the fifth movement restricting portion 455 is provided between the outer side portion 121A of the attracting magnetic pole 121 and, of the lower transport member 440, the portion located in the one region 11X.

Here, it is further assumed that a plane 11B is a plane extending along the axial center 440A of the lower transport member 440 and passing through the magnetic pole 121 and an outer peripheral portion 440E of the lower transport member 440.

More specifically, it is assumed that the plane 11B is a plane extending along the axial center 440A of the lower transport member 440 and passing, of the outer peripheral portion 440E of the lower transport member 440, a portion located on the one region 11X side.

In more detail, it is assumed here that the plane 11B is a plane that has a relationship of being a tangent plane with respect to, of the outer peripheral portion 440E of the lower transport member 440, the portion located on the one region 11X side and assumed that the plane 11B extends along the axial center 440A of the lower transport member 440 and passes through the outer side portion 121A of the magnetic pole 121.

In the configuration according to the present exemplary embodiment, the fifth movement restricting portion 455 is located on the plane 11B.

The fifth movement restricting portion 455 is formed of a plate-like member and has elasticity. The fifth movement restricting portion 455 is supported by a holder 100D provided inside the developing device 14.

The fifth movement restricting portion 455 is disposed to extend downward obliquely from the holder 100D and has a tip portion 455A at the tip thereof in a direction in which the fifth movement restricting portion 455 extends. The fifth movement restricting portion 455 is supported at a base portion 455B by the holder 100D.

The fifth movement restricting portion 455 is made of a non-magnetic material.

Specifically, the fifth movement restricting portion 455 in the present exemplary embodiment is made of a non-magnetic metal material, such as stainless steel. The fifth movement restricting portion 455 may be made of a resin material.

If made of a magnetic material, the fifth movement restricting portion 455 may affect the charged toner. More specifically, the fifth movement restricting portion 455 may affect, for example, the developer that moves from the one-direction transport member 410 onto the facing member 430. In this case, a malfunction in which, for example, the quality of an image to be formed is deteriorated may occur.

In contrast, when the fifth movement restricting portion 455 is made of, as in the present exemplary embodiment, a non-magnetic material, occurrence of such a malfunction may be suppressed.

In the present exemplary embodiment, there is a likelihood of the developer being splashed by the lower transport member 440 that rotates. In this case, when the developer moves toward a magnetic-pole facing portion, which is a portion of the facing member 430 at a location facing the magnetic pole 121, the developer adheres to the facing member 430.

In this case, the developer moves toward the photoconductor drum 11 without passing through the supplying mechanism 850 having the stirring function.

In the present exemplary embodiment, as described above, the number of rotation of the lower transport member 440 is larger than the number of rotation of the one-direction transport member 410, which causes the developer to splash easily.

When, as in the present exemplary embodiment, the fifth movement restricting portion 455 is provided, the splashed developer may tend not to move easily toward the magnetic-pole facing portion of the facing member 430. In this case, the developer that has not passed through the supplying mechanism 850 may be not easily supplied to the photoconductor drum 11.

Further, as described above, there is provided in the present exemplary embodiment the second movement restricting portion 452 that is disposed between the lower transport member 440 and the opposite-direction transport member 420 and that restricts the movement of the developer from the opposite-direction transport member 420 to the lower transport member 440.

Consequently, in the present exemplary embodiment, occurrence of a situation in which the developer from the opposite-direction transport member 420 moves toward the photoconductor drum 11 via the lower transport member 440 and the facing member 430 may be avoided. In this case, occurrence of a situation in which the developer in the middle of being stirred by the supplying mechanism 850 moves toward the photoconductor drum 11 may be avoided.

In addition, as described above, there is provided in the present exemplary embodiment the third movement restricting portion 453 that is disposed between the facing member 430 and the opposite-direction transport member 420 and that restricts the movement of the developer from the opposite-direction transport member 420 to the facing member 430.

The provision of the third movement restricting portion 453 suppresses occurrence of a situation in which the developer moves directly toward the facing member 430 from the opposite-direction transport member 420, and also in this case, occurrence of a situation in which the developer in the middle of being stirred by the supplying mechanism 850 moves toward the photoconductor drum 11 may be avoided.

Further, in the present exemplary embodiment, the fifth movement restricting portion 455 is disposed with a gap between the fifth movement restricting portion 455 and the facing member 430.

In addition, in the present exemplary embodiment, the gap between the facing member 430 and the fifth movement restricting portion 455 is larger than the gap between the facing member 430 and the facing restriction portion 127.

More specifically, in the present exemplary embodiment, the size of the gap between the facing member 430 and the fifth movement restricting portion 455 is twice or more the size of the gap between the facing member 430 and the facing restriction portion 127.

Consequently, in the present exemplary embodiment, both of the developer that moves, while adhering to the surface of the facing member 430, to the downstream side in the rotation direction of the facing member 430 from the location facing the photoconductor drum 11 and the developer that separates on the front side of the magnetic pole 121 from the facing member 430 and moves downward pass through the gap between the facing member 430 and the fifth movement restricting portion 455.

Here, it is assumed that the gap between the facing member 430 and the fifth movement restricting portion 455 is smaller than the gap between the facing member 430 and the facing restriction portion 127.

In this case, part of the developer that moves, while adhering to the surface of the facing member 430, to the downstream side in the rotation direction of the facing member 430 from the location facing the photoconductor drum 11 is caught by the fifth movement restricting portion 455.

Here, it is assumed that the size of the gap between the facing member 430 and the fifth movement restricting portion 455 is larger than the size of the gap between the facing member 430 and the facing restriction portion 127 while the size of the gap between the facing member 430 and the fifth movement restricting portion 455 is less than twice the size of the gap between the facing member 430 and the facing restriction portion 127.

In this case, the developer that has separated on the front side of the magnetic pole 121 from the facing member 430 may become impossible to pass through the gap between the facing member 430 and the fifth movement restricting portion 455.

In the present exemplary embodiment, the developer that moves, while adhering to the surface of the facing member 430, to the downstream side in the rotation direction of the facing member 430 from the location facing the photoconductor drum 11 once passes through the gap between the facing member 430 and the fifth movement restricting portion 455.

Then, after separating at the separation portion 296 located on the front side of the magnetic pole 121 from the facing member 430, the developer passes through the gap again in the process of moving downward.

When the size of the gap between the facing member 430 and the fifth movement restricting portion 455 is less than twice the size of the gap between the facing member 430 and the facing restriction portion 127, the developer that separates from the facing member 430 and moves downward may become impossible to pass through the gap.

Further, in the present exemplary embodiment, the fifth movement restricting portion 455 is disposed in a state of being inclined with respect to the horizontal direction. Specifically, the tip portion 455A in the protruding direction is configured to be located below the base portion 455B.

Moreover, in the present exemplary embodiment, the angle of the inclination of the fifth movement restricting portion 455 with respect to the horizontal direction is more than or equal to the angle of repose of the developer.

Consequently, in the present exemplary embodiment, the developer that has separated from the facing member 430 and has been placed on the fifth movement restricting portion 455 may easily move to the lower transport member 440 side.

Further, the fifth movement restricting portion 455 is provided with a bent portion 455C extending in the axial direction of the facing member 430. In other words, the fifth movement restricting portion 455 is provided with the bent portion 455C extending in the longitudinal direction of the fifth movement restricting portion 455.

In the present exemplary embodiment, the fifth movement restricting portion 455 has an L-shape at a cross-section of the fifth movement restricting portion 455 at a surface orthogonal to the longitudinal direction of the fifth movement restricting portion 455. Consequently, in the present exemplary embodiment, the stiffness of the fifth movement restricting portion 455 with respect to torsion is increased.

More specifically, the stiffness of the fifth movement restricting portion 455 when one end portion of the fifth movement restricting portion 455 in the longitudinal direction is rotated about the center axis extending in the longitudinal direction is increased.

In the present exemplary embodiment, the fifth movement restricting portion 455 is formed by a plate-like member, and the fifth movement restricting portion 455 is formed by a component that is separate from the body portion of the developing device 14.

The fifth movement restricting portion 455 is, however, not limited thereto. For example, a portion of a housing that is provided at the developing device 14 may protrude, and the fifth movement restricting portion 455 may be formed by the protruding portion.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX 1

(((1)))

A developing device comprising:
a developer moving unit that circularly moves a developer, the developer moving unit including
   a one-direction transport member that transports the developer in one direction, and
   an opposite-direction transport member that is disposed below the one-direction transport member and that transports the developer in a direction opposite to the one direction;
a facing member that is disposed at a location facing an image carrier and that supplies the image carrier with the developer supplied from the one-direction transport member;
a lower transport member that is disposed below the facing member and that transports the developer that has separated from the facing member in the one direction to cause the developer to be supplied to one end portion side of the opposite-direction transport member; and
a movement restricting portion that is disposed between the lower transport member and the opposite-direction transport member and that restricts a movement of the developer from the opposite-direction transport member to the lower transport member.
   (((2)))

The developing device according to (((1))), further comprising:
a movement restricting portion that is disposed between the facing member and the opposite-direction transport member and that restricts a movement of the developer from the opposite-direction transport member to the facing member.
   (((3)))

The developing device according to (((2))),
wherein the movement restricting portion that is disposed between the lower transport member and the opposite-direction transport member and the movement restricting portion that is disposed between the facing member and the opposite-direction transport member are integrated together.
   (((4)))

The developing device according to any one of (((1))) to (((3))),
wherein the facing member and the one-direction transport member are each a rotary member that rotates about an axial center extending in the one direction, and
wherein an axial center of the one-direction transport member is located above an axial center of the facing member.
   (((5)))

The developing device according to any one of (((1))) to (((3))),
wherein the facing member, the one-direction transport member, and the opposite-direction transport member are each a rotary member that rotates about an axial center extending in the one direction, and
wherein an axial center of the opposite-direction transport member is located farther than an axial center of the one-direction transport member from the facing member when the axial centers are compared with each other in terms of positions in a horizontal direction.
   (((6)))

The developing device according to any one of (((1))) to (((3))),
wherein the facing member and the lower transport member are each a rotary member that rotates about an axial center extending in the one direction, and
wherein an axial center of the lower transport member is located off a portion that is immediately under an axial center of the facing member.
   (((7)))

The developing device according to (((6))),
wherein the one-direction transport member and the opposite-direction transport member are each a rotary member that rotates about an axial center extending in the one direction,
wherein an axial center of the opposite-direction transport member is located farther than an axial center of the one-direction transport member from the facing member when the axial centers are compared with each other in terms of positions in a horizontal direction, and
wherein the axial center of the lower transport member is located closer than the axial center of the facing member to the opposite-direction transport member when the axial centers are compared with each other in terms of positions in the horizontal direction.
   (((8)))

The developing device according to any one of (((1))) to (((3))),
wherein the lower transport member and the opposite-direction transport member are each a rotary member that rotates about an axial center extending in the one direction, and
wherein an axial center of the lower transport member is located below an axial center of the opposite-direction transport member.
   (((9)))

The developing device according to any one of (((1))) to (((8))), further comprising:
a movement path for the developer that moves from the lower transport member toward the opposite-direction transport member,
wherein, in an axial direction of the facing member, the movement path is located off an adhesion region that is a region included in the facing member and to which the developer adheres.
   (((10)))

The developing device according to any one of (((1))) to ((9))), further comprising:
a first movement path through which the developer that moves from the one-direction transport member toward the opposite-direction transport member passes and a second movement path through which the developer that moves from the opposite-direction transport member toward the one-direction transport member passes,
wherein, in an axial direction of the facing member, the first movement path and the second movement path are located off an adhesion region that is a region included in the facing member and to which the developer adheres.
   (((11)))

The developing device according to (((1))), further comprising:
a movement path through which the developer that moves from the lower transport member toward the opposite-direction transport member passes; and
a suppressing portion that suppresses returning of the developer that has moved to the opposite-direction transport member toward the lower transport member through the movement path.
   (((12)))

The developing device according to (((11))),
wherein the suppressing portion is formed by a projection that projects upward from a lower surface of the movement path.
   (((13)))

The developing device according to any one of (((1))) to (((12))),
wherein the lower transport member and the opposite-direction transport member are disposed to extend in the one direction and disposed in a state in which positions of the lower transport member and the opposite-direction transport member in a horizontal direction are displaced from each other,
wherein, in a path through which the developer that is transported by the lower transport member moves, the developer moves while being gathered on a side where the opposite-direction transport member is located, and
wherein, in a path through which the developer that is transported by the opposite-direction transport member moves, the developer moves while being gathered on a side opposite to a side where the lower transport member is located.
   (((14)))

The developing device according to (((1))),
wherein the lower transport member and the one-direction transport member are each a rotary member that rotates about an axial center extending in the one direction, and
wherein an outer diameter of the lower transport member is less than or equal to a value that is obtained by multiplying an outer diameter of the one-direction transport member by 1.15 and more than or equal to a value that is obtained by multiplying the outer diameter of the one-direction transport member by 0.85.
   (((15)))

The developing device according to (((1))),
wherein the lower transport member and the one-direction transport member are each a rotary member that rotates about an axial center extending in the one direction, and
wherein the number of rotation of the lower transport member is more than or equal to the number of rotation of the one-direction transport member.
   (((16)))

An image forming device comprising:
an image carrier; and
a developing device that performs development with respect of the image carrier and forms an image on the image carrier,
wherein the developing device includes the developing device according to any one of (((1))) to (((15))).

### APPENDIX 2

(((1)))

A developing device comprising:
a facing member that is disposed at a location facing an image carrier and that is used to supply a developer to the image carrier;
a supplying unit that has a stirring function of stirring the developer and that supplies the facing member with the developer;
a transport member that transports the developer that has separated from the facing member to the supplying unit having the stirring function; and
a movement restricting portion that is disposed between the facing member and the transport member and that restricts a movement of the developer from the transport member to the facing member.
   (((2)))

The developing device according to (((1))), further comprising:
an attracting magnetic pole that causes the developer supplied from the supplying unit to be attracted onto an outer peripheral surface of the facing member,
wherein the movement restricting portion is disposed between the attracting magnetic pole and the transport member.
   (((3)))

The developing device according to (((2))),
wherein the transport member is a member that rotates about a rotary shaft extending in an axial direction of the facing member,
wherein the transport member includes a portion that is located on a side of one region and that moves toward the facing member, and a portion that is located on a side of another region and that moves away from the facing member, the one region and the other region being two regions facing each other with a plane therebetween, the plane extending along an axial center of the transport member and passing through both the attracting magnetic pole and the axial center, and
wherein the movement restricting portion is disposed between the attracting magnetic pole and, of the transport member, a portion located in the one region.
   (((4)))

The developing device according to (((1))), further comprising:
an attracting magnetic pole that causes the developer supplied from the supplying unit to be attracted onto an outer peripheral surface of the facing member,
wherein the transport member is a member that rotates about a rotary shaft extending in an axial direction of the facing member, and
wherein the movement restricting portion is located on a plane, the plane extending along an axial center of the transport member and passing through the attracting magnetic pole and an outer peripheral portion of the transport member.
   (((5)))

The developing device according to any one of (((1))) to (((4))), wherein the movement restricting portion is made of a non-magnetic material.

(((6)))

The developing device according to (((5))), wherein the movement restricting portion is made of a resin material.

(((7)))

The developing device according to (((5))), wherein the movement restricting portion is made of a non-magnetic metal material.

(((8)))

The developing device according to any one of (((1)) to (((7))), wherein the movement restricting portion is disposed with a gap between the movement restricting portion and the facing member.

(((9)))

The developing device according to (((8))), further comprising:
a facing restriction portion that is disposed at a location facing an outer peripheral surface of the facing member and restricts a movement of part of the developer that adheres to the outer peripheral surface and moves toward the image carrier with rotation of the facing member,
wherein the gap between the facing member and the movement restricting portion is larger than a gap between the facing member and the facing restriction portion.
   (((10)))

The developing device according to (((9))), wherein a size of the gap between the facing member and the movement restricting portion is twice or more a size of the gap between the facing member and the facing restriction portion.

(((11)))

The developing device according to any one of (((1))) to (((10))), wherein the movement restricting portion is provided with a bent portion extending in an axial direction of the facing member.

(((12)))

The developing device according to any one of (((1))) to (((11))), wherein the movement restricting portion is disposed in a state of being inclined with respect to a horizontal direction.

(((13)))

The developing device according to (((12))), wherein an angle of an inclination of the movement restricting portion with respect to the horizontal direction is more than or equal to an angle of repose of the developer.

(((14)))

An image forming device comprising:
an image carrier, and
a developing device that performs development with respect of the image carrier and forms an image on the image carrier,
wherein the developing device includes the developing device according to any one of (((1))) to (((13))).

What is claimed is:

1. A developing device comprising:
a developer moving unit that circularly moves a developer, the developer moving unit including
a one-direction transport member that transports the developer in one direction, and
an opposite-direction transport member that is disposed below the one-direction transport member and that transports the developer in a direction opposite to the one direction;
a facing member that is disposed at a location facing an image carrier and that supplies the image carrier with the developer supplied from the one-direction transport member;
a lower transport member that is disposed below the facing member and that transports the developer that has separated from the facing member in the one direction to cause the developer to be supplied to one end portion side of the opposite-direction transport member; and
a movement restricting portion that is disposed between the lower transport member and the opposite-direction transport member and that restricts a movement of the developer from the opposite-direction transport member to the lower transport member.

2. The developing device according to claim 1, further comprising:
a movement restricting portion that is disposed between the facing member and the opposite-direction transport member and that restricts a movement of the developer from the opposite-direction transport member to the facing member.

3. The developing device according to claim 2,
wherein the movement restricting portion that is disposed between the lower transport member and the opposite-direction transport member and the movement restricting portion that is disposed between the facing member and the opposite-direction transport member are integrated together.

4. The developing device according to claim 1,
wherein the facing member and the one-direction transport member are each a rotary member that rotates about an axial center extending in the one direction, and
wherein an axial center of the one-direction transport member is located above an axial center of the facing member.

5. The developing device according to claim 1,
wherein the facing member, the one-direction transport member, and the opposite-direction transport member are each a rotary member that rotates about an axial center extending in the one direction, and
wherein an axial center of the opposite-direction transport member is located farther than an axial center of the one-direction transport member from the facing member when the axial centers are compared with each other in terms of positions in a horizontal direction.

6. The developing device according to claim 1,
wherein the facing member and the lower transport member are each a rotary member that rotates about an axial center extending in the one direction, and
wherein an axial center of the lower transport member is located off a portion that is immediately under an axial center of the facing member.

7. The developing device according to claim 6,
wherein the one-direction transport member and the opposite-direction transport member are each a rotary member that rotates about an axial center extending in the one direction,
wherein an axial center of the opposite-direction transport member is located farther than an axial center of the one-direction transport member from the facing member when the axial centers are compared with each other in terms of positions in a horizontal direction, and
wherein the axial center of the lower transport member is located closer than the axial center of the facing member to the opposite-direction transport member when the axial centers are compared with each other in terms of positions in the horizontal direction.

8. A developing device comprising:
a facing member that is disposed at a location facing an image carrier and that is used to supply a developer to the image carrier;
a supplying unit that has a stirring function of stirring the developer and that supplies the facing member with the developer;
a transport member that transports the developer that has separated from the facing member to the supplying unit having the stirring function; and
a movement restricting portion that is disposed between the facing member and the transport member and that restricts a movement of the developer from the transport member to the facing member.

9. The developing device according to claim 8, further comprising:
an attracting magnetic pole that causes the developer supplied from the supplying unit to be attracted onto an outer peripheral surface of the facing member,
wherein the movement restricting portion is disposed between the attracting magnetic pole and the transport member.

10. The developing device according to claim 9,
wherein the transport member is a member that rotates about a rotary shaft extending in an axial direction of the facing member,
wherein the transport member includes a portion that is located on a side of one region and that moves toward the facing member, and a portion that is located on a side of another region and that moves away from the facing member, the one region and the other region being two regions facing each other with a plane between the two regions, the plane extending along an axial center of the transport member and passing through both the attracting magnetic pole and the axial center, and
wherein the movement restricting portion is disposed between the attracting magnetic pole and, of the transport member, a portion located in the one region.

11. The developing device according to claim 8, further comprising:
an attracting magnetic pole that causes the developer supplied from the supplying unit to be attracted onto an outer peripheral surface of the facing member,
wherein the transport member is a member that rotates about a rotary shaft extending in an axial direction of the facing member, and
wherein the movement restricting portion is located on a plane, the plane extending along an axial center of the transport member and passing through the attracting magnetic pole and an outer peripheral portion of the transport member.

12. The developing device according to claim 8,
wherein the movement restricting portion is made of a non-magnetic material.

13. The developing device according to claim 12,
wherein the movement restricting portion is made of a resin material.

14. The developing device according to claim 12,
wherein the movement restricting portion is made of a non-magnetic metal material.

15. The developing device according to claim 8,
wherein the movement restricting portion is disposed with a gap between the movement restricting portion and the facing member.
